(19) United States
(12) Patent Application Publication
(10) Pub. No.: US 2026/0161223 A1
(43) Pub. Date: Jun. 11, 2026

(54) LINE-OF-SIGHT DETECTION APPARATUS

(71) Applicant: CANON KABUSHIKI KAISHA, Tokyo (JP)

(72) Inventor: SAKI NAKAMICHI, Kanagawa (JP)

(21) Appl. No.: 19/180,404

(22) Filed: Apr. 16, 2025

(30) Foreign Application Priority Data
Apr. 23, 2024 (JP) 2024-069482

(51) Int. Cl. G06F 3/01; H04N 23/20; H04N 23/56

(52) U.S. Cl. CPC G06F 3/013; H04N 23/20; H04N 23/56

(57) ABSTRACT

A line-of-sight detection apparatus includes: a display apparatus; an optical system configured to deliver first light of an image displayed by the display apparatus to an eye of a user along an optical axis; a lighting apparatus including a light-emitting member configured to irradiate the eye with second light; a light-shielding member having an opening configured to limit an irradiation range of the second light with which the light-emitting member irradiates the eye; and an imaging apparatus configured to captures the eye on a basis of the second light reflected by the eye. A distance from the light-emitting member to the optical axis is longer than a distance from an intersection of a plane orthogonal to the optical axis and passing through the light-emitting member and a central axis of the first opening to the optical axis.

### BACKGROUND OF THE INVENTION

### Field of the Invention

The present invention relates to a line-of-sight detection apparatus.

### Description of the Related Art

In the fields of VR, AR, and the like, a head-mounted display that realizes functions such as menu selection by using a detected gaze point (gaze position) of a user has been put into practical use. In addition, also in the field of cameras and the like, a product for selecting a distance measurement point on the basis of a detected line-of-sight direction has been put into practical use.

In line-of-sight detection, in order to detect a gaze point of the user, a line-of-sight sensor acquires an image obtained by imaging an eyeball of the user. At this time, a lighting arranged around an eyepiece optical system irradiates the eyeball of the user with light. Since the irradiation light is specularly reflected on the surface of the cornea, a corneal reflection image appears in the image acquired by the line-of-sight sensor. The line-of-sight sensor detects coordinates of the corneal reflection image in the image. Here, if aberration occurs in the corneal reflection image, an error occurs in the detection of the luminance centroid coordinates of the corneal reflection image, and thus, the accuracy of line-of-sight detection is reduced.

Conventionally, measures for correcting this aberration have been studied. JP 8-234136 A discloses an example in which a prism for correcting aberration is disposed in front of a line-of-sight sensor.

However, the technique disclosed in JP 8-234136 A requires a prism, and thus the size of the line-of-sight detection apparatus increases.

### SUMMARY OF THE INVENTION

The present invention provides a line-of-sight detection apparatus capable of preventing an increase in size and detecting a line-of-sight with high accuracy.

The present invention in one of its aspects provides a line-of-sight detection apparatus includes: a display apparatus an optical system configured to deliver first light of an image displayed by the display apparatus to an eye of a user along an optical axis; a first lighting apparatus including a first light-emitting member configured to irradiate the eye of the user with second light; a first light-shielding member having a first opening configured to limit an irradiation range of the second light with which the first light-emitting member irradiates the eye of the user; and an imaging apparatus configured to captures the eye of the user on a basis of the second light reflected by the eye of the user; wherein a distance from a position of the first light-emitting member to the optical axis is longer than a distance from a first intersection of a plane orthogonal to the optical axis and passing through the position of the first light-emitting member and a central axis of the first opening to the optical axis.

Further features of the present invention will become apparent from the following description of exemplary embodiments with reference to the attached drawings.

### BRIEF DESCRIPTION OF THE DRAWINGS

FIG. 1 is a central longitudinal sectional view of a camera body according to First Embodiment;

FIG. 2 is a diagram illustrating a configuration related to a line-of-sight sensor unit according to First Embodiment;

FIG. 3 is a diagram illustrating an EVF unit according to First Embodiment;

FIGS. 4A and 4B are diagrams illustrating an apparatus according to a comparative example of First Embodiment;

FIGS. 5A and 5B are diagrams illustrating an apparatus according to a comparative example of First Embodiment;

FIGS. 6A and 6B are diagrams illustrating a positional relationship of the configuration in the camera body according to First Embodiment;

FIGS. 7A and 7B are diagrams illustrating a positional relationship of the configuration in a camera body according to Second Embodiment;

FIGS. 8A to 8C are diagrams each illustrating a positional relationship of the configuration in the camera body according to Second Embodiment;

FIGS. 9A and 9B are diagrams illustrating a positional relationship of the configuration in a camera body according to Third Embodiment; and

FIGS. 10A to 10C are diagrams each illustrating a positional relationship of the configuration in the camera body according to Third Embodiment.

### DESCRIPTION OF THE EMBODIMENTS

### First Embodiment

An imaging apparatus (line-of-sight detection apparatus) including a camera body 1 according to First Embodiment will be described in detail. Here, in the most basic standard orientation (so-called normal position) of the camera body 1, an optical-system optical axis of an imaging optical system (not illustrated) is set as a “Z axis”, and the vertically opposite direction of the Z axis is set as a “Y axis” direction. A right-handed axis orthogonal to the Y axis and the Z axis is set as an “X axis”.

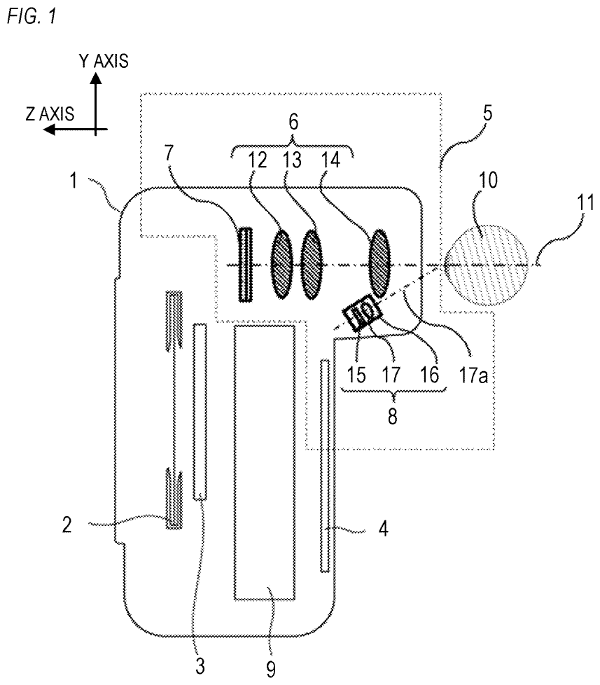

FIG. 1 is a schematic view (so-called central longitudinal sectional view) of the camera body 1 cut along a plane parallel to the Y axis and the Z axis. The camera body 1 includes a shutter 2, an imaging sensor 3, a rear monitor 4, an electronic view finder (EVF) unit 5, and a CPU 9.

The shutter 2 and the imaging sensor 3 are arranged in the Z-axis direction (the optical-axis direction of the imaging optical system).

The rear monitor 4 is provided on the rear surface of the camera body 1. The rear monitor 4 displays a menu and an image in order to realize viewing and editing of an image obtained by the camera body 1. The rear monitor 4 has a liquid crystal panel with a backlight or an organic EL panel.

The EVF unit 5 includes a display unit 7, a display optical system 6, and a line-of-sight sensor unit 8. The EVF unit 5 is built in or attached to the camera body 1 such that a user who uses the camera body 1 can visually recognize the display surface of the display unit 7.

The display unit (display apparatus) 7 is an EVF panel (an organic EL panel or a liquid crystal display panel with a backlight, or the like) having an information display surface. In First Embodiment, the display surface of the display unit 7 is directed to the Z-axis negative direction.

The display optical system 6 is disposed in front of the display surface of the display unit 7. The display optical system 6 includes one or a plurality of lenses arranged along the optical axis 11 of the display optical system 6 extending in the Z-axis negative direction. The display optical system 6 delivers light (visible light) of an image displayed by the display unit (display apparatus) 7 to an eye of the user along the optical axis 11. Each lens in the display optical system 6 is a lens of optical glass or transparent optical plastic. Each lens is manufactured by using “cutting and grinding” or “molding”.

In First Embodiment, the display optical system 6 includes three optical lenses including a G1 lens 12, a G2 lens 13, and a G3 lens 14 as three optical lenses that transmit visible light. However, the number of lenses included in the display optical system 6 is not limited to three, and may be any number such as four or five. Therefore, the display optical system 6 can include an appropriate number of lenses for realizing enlarged display of the image displayed on the display unit 7.

The line-of-sight sensor unit 8 is an eyeball imaging unit (imaging apparatus) that forms an image of the eyeball 10 of the user looking into the EVF unit 5 on a line-of-sight sensor chip 15. The line-of-sight sensor unit 8 acquires an image obtained by imaging the eyeball 10 by imaging infrared light reflected by the eyeball 10 (eye of the user). In the line-of-sight sensor unit 8, a line-of-sight sensor lens 17 and the line-of-sight sensor chip 15 are arranged on an optical axis 17a of the line-of-sight sensor lens 17 inside a line-of-sight sensor housing 16. The line-of-sight sensor unit 8 is a small camera on a module packaged in the line-of-sight sensor housing 16. However, each component in the line-of-sight sensor unit 8 does not need to be packaged.

The line-of-sight sensor lens 17 is an optical system (optical lens) necessary for forming an image of the eyeball 10 on the line-of-sight sensor chip 15. In FIG. 1, for convenience, the line-of-sight sensor lens 17 is represented by one lens, but the line-of-sight sensor lens 17 may be configured using a plurality of lenses.

The line-of-sight sensor chip 15 is an image sensor (eyeball imaging sensor) that performs A/D conversion (analog-digital conversion) of an image including an infrared component of the eyeball 10 and inputs the result to the CPU 9. As the line-of-sight sensor chip 15, a CMOS imaging sensor or a CCD matrix sensor is used.

The CPU 9 is a control unit that controls each component of the camera body 1. The CPU 9 performs input/output processing of various types of necessary information on the EVF unit 5, the display optical system 6, the shutter 2, and the rear monitor 4, similarly to a general camera.

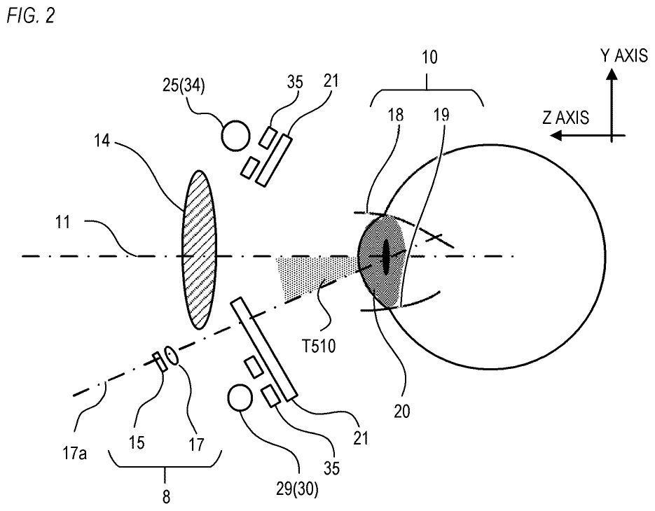

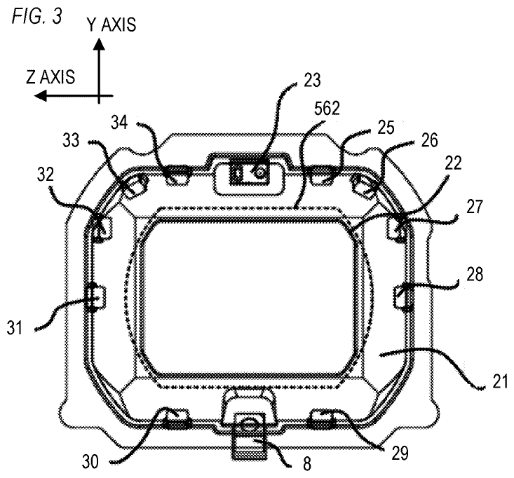

A configuration related to the line-of-sight sensor unit 8 of the EVF unit 5 will be described in detail with reference to FIGS. 2 and 3.

FIG. 2 is a schematic diagram illustrating components related to the line-of-sight sensor unit 8 by extracting the EVF unit 5 from the cross-sectional view of the camera body 1 illustrated in FIG. 1. FIG. 3 is a schematic diagram of the EVF unit 5 as viewed from the user's eyeball 10 side (that is, the Z-axis positive direction side).

In a case where the user looks into the display surface of the display unit 7 of the EVF unit 5, as illustrated in FIG. 2, the eyeball 10 of the user is located near the G3 lens 14 on the optical axis 11. On the eyeball 10, there are an upper eyelid 18 and a lower eyelid 19. A cornea 20 is exposed from between the two eyelids.

A plurality of lightings 24 is arranged around the G3 lens 14. As illustrated in FIG. 3, the plurality of lightings 24 is a plurality of lighting elements (lighting apparatuses) such as infrared-emitting diodes (IREDs) 25 to 34. The lighting 24 includes a light-emitting unit 37 which is an IRED chip inside. The light-emitting unit 37 emits infrared light as illumination light to illuminate the eyeball 10. In First Embodiment, when the light-emitting unit 37 irradiates the eyeball 10 with illumination light, the illumination light is specularly reflected by the surface of the cornea 20. Then, since the specular reflection image of the light-emitting unit 37 is captured by the line-of-sight sensor chip 15, the luminance centroid position of the captured specular reflection image is used for line-of-sight detection calculation.

An infrared-light transmitting cover 21 includes resin that absorbs visible light and transmits infrared light. The infrared-light transmitting cover 21 is formed in a rectangular frame shape as illustrated in FIG. 3, and surrounds the periphery of the G3 lens 14. The infrared-light transmitting cover 21 is a window that covers the lighting 24 such that the state of the lighting 24 is not visible from the outside. The infrared-light transmitting cover 21 is provided with an opening 22 (an opening 22 for the user to see the display unit 7) through which an effective light flux of visible light of the G3 lens 14 passes. The opening 22 is not limited to a physical opening, and is only required to transmit visible light. For example, the infrared-light transmitting cover 21 may be configured by applying infrared light transmitting paint to the G3 lens 14. Furthermore, a portion where the infrared light transmitting paint is not applied may be provided on the G3 lens 14, and the portion may be treated as the opening 22.

A light-shielding member 35 including a substance (resin or metal) that does not transmit infrared light is disposed between the lighting 24 and the infrared-light transmitting cover 21. The light-shielding member 35 forms a substantially circular opening 36. The opening 36 regulates (limits) a light flux of light emitted from the light-emitting unit 37.

A proximity sensor 23 for detecting proximity of the eyeball 10 is arranged around the G3 lens 14. The proximity sensor 23 is a unit including an infrared light emission unit and an infrared light reception unit. The proximity sensor 23 measures a distance between the G3 lens 14 and the eyeball 10 by using, for example, a reflection angle, a time difference, and a frequency of infrared light emitted by the infrared light emission unit. Information on the distance measured by the proximity sensor 23 (distance information) is sent to the CPU 9. The CPU 9 uses the distance information, for example, for lighting control of the display unit 7 or the lighting 24. The proximity sensor 23 is hidden by the infrared-light transmitting cover 21 so as not to be visually recognized by the user.

The optical axis 11 and the optical axis 17a of the line-of-sight sensor lens 17 are not parallel, but form an angle T510. Specifically, in the normal position state of the camera body 1, the line-of-sight sensor unit 8 is disposed at a position on the negative side in the Y-axis direction in the EVF unit 5. The optical axis 17a of the line-of-sight sensor lens 17 is directed to the Y-axis positive direction on the YZ plane with respect to the optical axis 11 extending in the Z-axis direction.

Ten IREDs (lightings 24) are arranged so as to surround the periphery of the G3 lens 14. As illustrated in FIG. 3, an IRED 25, an IRED 26, an IRED 27, an IRED 28, an IRED 29, an IRED 30, an IRED 31, an IRED 32, an IRED 33, and an IRED 34 are arranged in a clockwise order around the optical axis 11.

### Problem of Line-of-Sight Detection Apparatus of Comparative Example

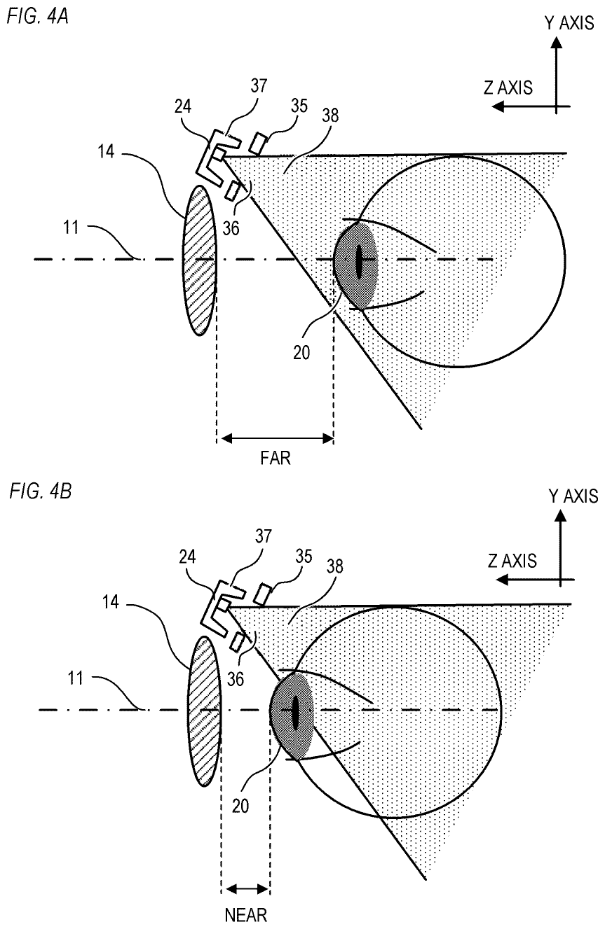

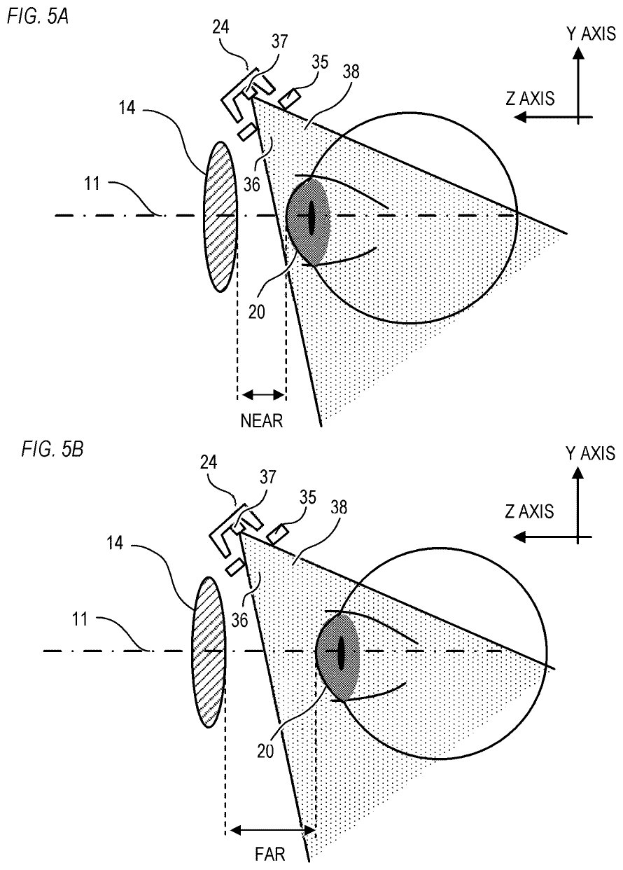

Here, with reference to FIGS. 4A, 4B, 5A, and 5B, problems occurring in line-of-sight detection apparatuses of comparative examples will be described.

First, “aberration” handled in First Embodiment will be described. There is a case where the specular reflection image of the light-emitting unit 37 reflected on the line-of-sight sensor chip 15 is an image having a shape extending in a specific direction without being formed at one point. This shift in image formation is called “aberration”. This aberration occurs due to loss of axial symmetry of the line-of-sight sensor lens 17, and is caused by non-uniformity of a lens material, insufficient accuracy of processing and assembly, and the like. When the aberration is large and the extension of the image becomes remarkable, the luminance centroid position of the image is moved, and the line-of-sight detection accuracy deteriorates.

Therefore, in First Embodiment, extension of the image is reduced by providing the opening 36 to regulate the flux of light (light flux) emitted from the light-emitting unit 37. According to such a configuration, it is possible to reduce the influence of movement of the luminance centroid position of the specular reflection image of the light-emitting unit 37 reflected on the line-of-sight sensor chip 15 due to the aberration. For this reason, degradation of the line-of-sight detection accuracy can be suppressed. The positional relationship between the opening 36 and the light-emitting unit 37 will be described later in detail.

FIGS. 4A and 4B are schematic diagrams each illustrating the eye of the user looking into an optical image on a display surface of a display unit 7 and a line-of-sight detection apparatus of a comparative example. In both FIGS. 4A and 4B, the positional relationship between the members constituting the line-of-sight detection apparatus is the same, but the positional relationship between the line-of-sight detection apparatus and the eyeball is different. FIG. 4A illustrates an example in which the distance (hereinafter referred to as “corneal distance”) between a G3 lens 14 and a cornea 20 in the direction of an optical axis 11 is long. FIG. 4B illustrates an example in which the corneal distance is short.

In FIG. 4A, the entire region of the cornea 20 is included in an irradiation range 38 of light emitted from a light-emitting unit 37 and having passed through an opening 36. That is, the light emitted from the light-emitting unit 37 can illuminate the entire region of the cornea 20. In such a configuration, “an optical path in which light emitted from the light-emitting unit 37 is specularly reflected by the surface of the cornea 20 and is received by a line-of-sight sensor chip 15” can be secured, and a specular reflection image of the light-emitting unit 37 can be acquired. Therefore, accurate line-of-sight detection can be realized.

In contrast, in FIG. 4B, a partial region of the cornea 20 is not included in the irradiation range 38 of light emitted from the light-emitting unit 37 and having passed through the opening 36. That is, the light emitted from the light-emitting unit 37 cannot illuminate part of the cornea 20. In such a configuration, “an optical path in which light emitted from the light-emitting unit 37 is specularly reflected by the surface of the cornea 20 and is received by the line-of-sight sensor chip 15” cannot be secured, and a specular reflection image of the light-emitting unit 37 cannot be acquired. Therefore, accurate line-of-sight detection cannot be realized.

For this reason, conventionally, in a case where the eye of the user looking into the optical image of the display surface of the display unit 7 moves to some extent, light emitted from the light-emitting unit 37 cannot illuminate the entire region of the cornea 20.

In contrast, in FIG. 5A, a lighting 24 and a light-shielding member 35 is shifted in the Y-axis positive direction and the Z-axis negative direction as compared with the arrangement illustrated in FIG. 4B. The angle formed by the light of the lighting 24 and an optical axis 11 is larger. As a result, even if an irradiation range 38 is changed and the corneal distance is short, light emitted from the light-emitting unit 37 can illuminate the entire region of the cornea 20. In such a configuration, “an optical path in which light emitted from the light-emitting unit 37 is specularly reflected by the surface of the cornea 20 and is received by a line-of-sight sensor chip 15” can be easily secured. This makes it easy to acquire the specular reflection image of the light-emitting unit 37, so that robustness of line-of-sight detection can be secured.

FIG. 5A illustrates a schematic diagram in a case where the corneal distance is short, and FIG. 5B illustrates a schematic diagram in a case where the corneal distance is long. In both FIGS. 5A and 5B, the positional relationship between the members constituting the line-of-sight detection apparatus is the same, but the positional relationship between the line-of-sight detection apparatus and the eyeball is different. With this configuration, even if the corneal distance is long, light emitted from the light-emitting unit 37 can illuminate the entire region of the cornea 20.

That is, with the line-of-sight detection apparatus having the configuration illustrated in FIGS. 5A and 5B, even if the eyeball of the user looking into the optical image of the display surface of the display unit 7 moves to some extent, light emitted from the light-emitting unit 37 can illuminate the entire region of the cornea 20. However, in such a configuration, members such as the lighting 24 and the light-shielding member 35 are close to the eyeball. In this case, even if the user tries to bring the eyeball of the user close to a display optical system 6, the face comes into contact with the members such as the light-shielding member 35 and an infrared-light transmitting cover 21, and there is a possibility that the eyeball cannot be brought close to the display optical system 6.

### Camera Body According to First Embodiment

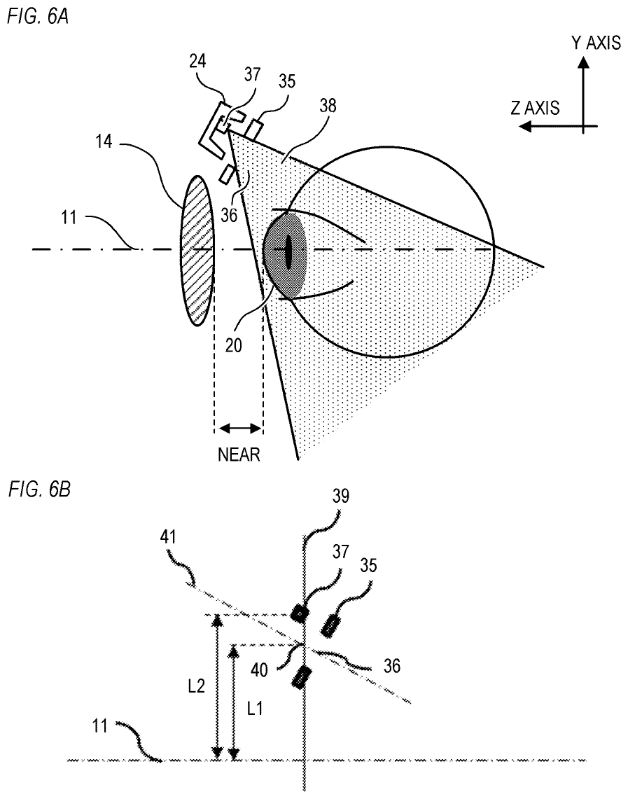

Therefore, a positional relationship between the light-emitting unit 37 and the opening 36 in the camera body 1, which is the line-of-sight detection apparatus according to First Embodiment will be described with reference to FIGS. 6A and 6B.

FIG. 6A illustrates a configuration of the camera body 1 according to First Embodiment. FIG. 6B illustrates a positional relationship between the light-emitting unit 37 and the opening 36 in detail.

In First Embodiment, the “centroid position of the light emitting region of the light-emitting unit 37” is referred to as the “position of the light-emitting unit 37”. In First Embodiment, the luminance centroid position of the specular reflection image of the light-emitting unit 37 received by the line-of-sight sensor chip 15 is used for line-of-sight detection calculation. Therefore, the centroid position of the light emitting region is used as a representative position.

In First Embodiment, as illustrated in FIG. 6B, a “straight line passing through a centroid position of the opening shape of the opening 36 and orthogonal to the opening shape” is referred to as a “central axis 41 of the opening”. In addition, a “plane orthogonal to the optical axis 11 and passing through the position of the light-emitting unit 37” is referred to as a “plane 39”. A “point at which the plane 39 intersects the central axis 41 of the opening” is referred to as an “intersection 40”. At this time, a distance L2 from the position of the light-emitting unit 37 to the optical axis 11 is longer than a distance L1 from the intersection 40 to the optical axis 11.

According to the configuration illustrated in FIGS. 6A and 6B, as compared with FIGS. 5A and 5B, the lighting 24 and the light-shielding member 35 can be disposed without being directed in the Y-axis negative direction. Therefore, light emitted from the light-emitting unit 37 can illuminate the entire region of the cornea 20 without causing members such as the lighting 24 and the light-shielding member 35 to protrude in the direction of the eyeball of the user. Since members such as the lighting 24 and the light-shielding member 35 do not protrude in the direction of the eyeball of the user, the user can bring the eyeball close to the display optical system 6. Therefore, the influence of the aberration of the corneal reflection image can be reduced without increasing the size of the line-of-sight detection apparatus (camera body 1), and the accuracy of line-of-sight detection can be secured.

### Second Embodiment

Hereinafter, a configuration of a camera body 1 in a case where two lightings 24 and two light-shielding members 35 are arranged will be described. Note that the description of the configuration similar to that of First Embodiment will be omitted.

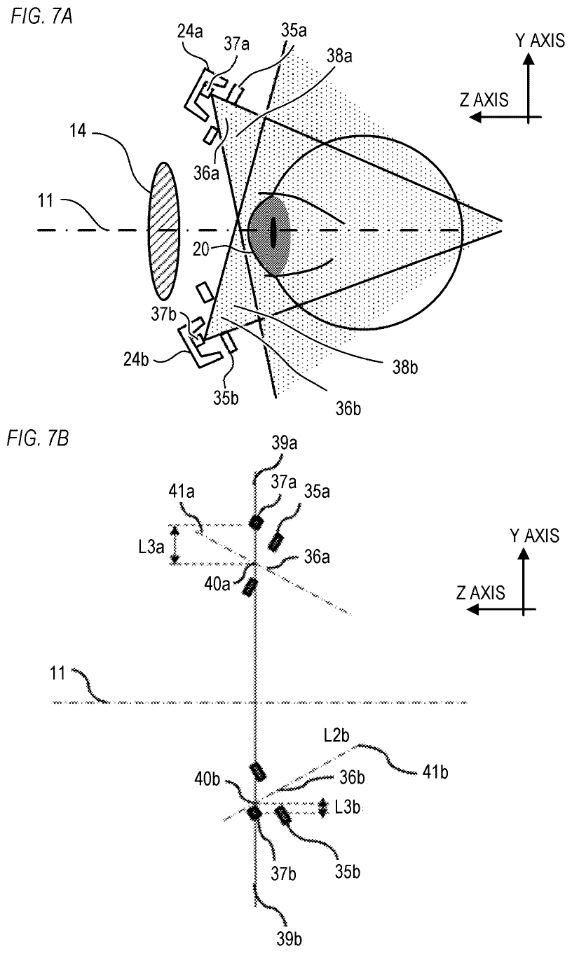

FIG. 7A illustrates an example in which two lightings 24 and two light-shielding members 35 are arranged, and illustrates an example in which the corneal distance (distance between a G3 lens 14 and a cornea 20 in the direction of an optical axis 11) is short.

Of the two lightings 24, the one with a longer distance between the position of a light-emitting unit 37 and the optical axis 11 is referred to as a “first lighting 24a”, and the one with a shorter distance between the position of a light-emitting unit 37 and the optical axis 11 is referred to as a “second lighting 24b”. The light-emitting unit 37 provided in the first lighting 24a is referred to as a “first light-emitting unit 37a”. The light-emitting unit 37 provided in the second lighting 24b is referred to as a “second light-emitting unit 37b”. Of the two light-shielding members 35, the light-shielding member having a longer distance from a line-of-sight sensor unit 8 is referred to as a “first light-shielding member 35a”, and the light-shielding member having a shorter distance from the line-of-sight sensor unit 8 is referred to as a “second light-shielding member 35b”. An opening 36 provided in the first light-shielding member 35a is referred to as a “first opening 36a”. An opening 36 provided in the second light-shielding member 35b is referred to as a “second opening 36b”. An irradiation range 38 of the light emitted from the first light-emitting unit 37a is referred to as a “first irradiation range 38a”. An irradiation range 38 of the light emitted from the second light-emitting unit 37b is referred to as a “second irradiation range 38b”.

FIG. 7B illustrates in detail a “positional relationship between the first light-emitting unit 37a and the first opening 36a” and a “positional relationship between the second light-emitting unit 37b and the second opening 36b”. A “straight line passing through a centroid position of the opening shape of the first opening 36a and orthogonal to the opening shape” is referred to as a “central axis 41a of the first opening”. A “straight line passing through a centroid position of the opening shape of the second opening 36b and orthogonal to the opening shape” is referred to as a “central axis 41b of the second opening”. A “plane orthogonal to the optical axis 11 and passing through the first light-emitting unit 37a” is referred to as a “first plane 39a”. A “plane orthogonal to the optical axis 11 and passing through the second light-emitting unit 37b” is referred to as a “second plane 39b”. A “point at which the first plane 39a intersects the central axis 41a of the first opening” is referred to as a “first intersection 40a”. A “point at which the second plane 39b intersects the central axis 41b of the second opening” is referred to as a “second intersection 40b”. A “distance from the position of the first light-emitting unit 37a to the first intersection 40a” is referred to as a “distance L3a”. A “distance from the position of the second light-emitting unit 37b to the second intersection 40b” is referred to as a “distance L3b”.

At this time, as illustrated in FIG. 7B, in the configuration in which the distance from the optical axis 11 to the position of the first light-emitting unit 37a is longer than the distance from the optical axis 11 to the position of the second light-emitting unit 37b, the distance L3a is longer than the distance L3b.

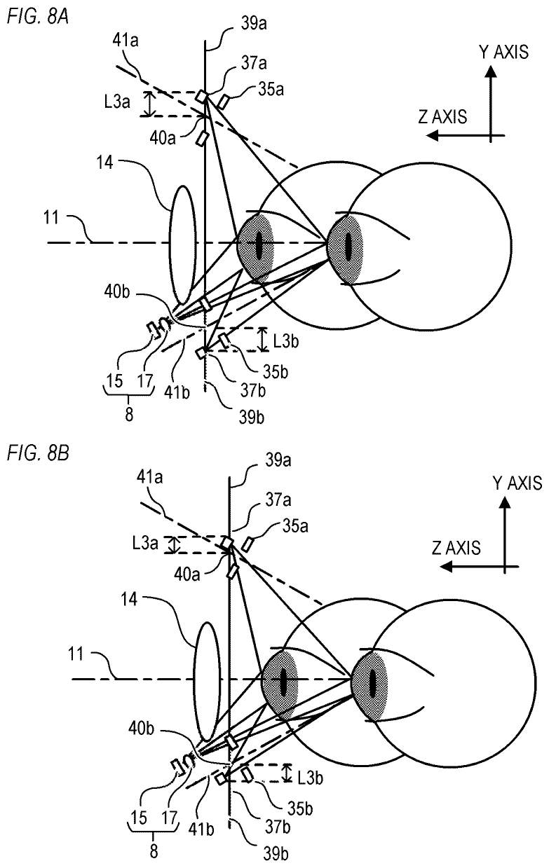

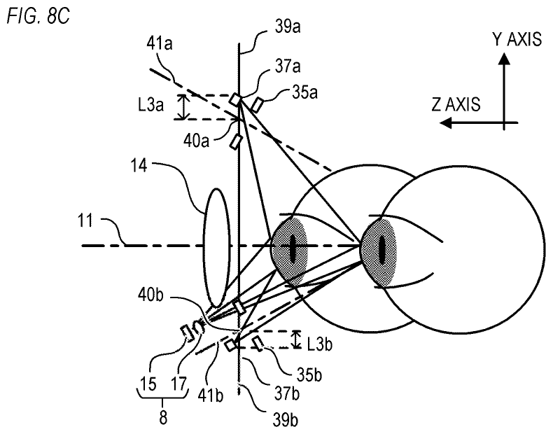

An effect of such a configuration will be described with reference to FIGS. 8A to 8C. Each of FIGS. 8A to 8C illustrates a schematic diagram in which an eyeball in a case where the corneal distance is long and an eyeball in a case where the corneal distance is short are overlapped. In addition, an optical path of light emitted from the first lighting 24a or the second lighting 24b, specularly reflected on the surface of the cornea 20, and directed to a line-of-sight sensor chip 15 is overlapped.

FIG. 8A illustrates a configuration example in a case where, suppose the distance L3a and the distance L3b are relatively long and equal to each other. In this example, in a case where the corneal distance is long, the light emitted from the second light-emitting unit 37b is blocked by the second light-shielding member 35b, so that the specular reflection image of the second light-emitting unit 37b cannot be acquired.

FIG. 8B illustrates a configuration example in a case where, suppose the distance L3a and the distance L3b are relatively short and equal to each other. In this example, in a case where the corneal distance is short, the light emitted from the first light-emitting unit 37a is blocked by the first light-shielding member 35a, so that the specular reflection image of the first light-emitting unit 37a cannot be acquired.

FIG. 8C illustrates a configuration example in a case where the distance L3a is longer than the distance L3b. FIG. 8C is a diagram illustrating the configuration according to Second Embodiment. In such a configuration, in both a case where the corneal distance is short and a case where the corneal distance long, specular reflection images of both the first light-emitting unit 37a and the second light-emitting unit 37b can be acquired, so that robustness of line-of-sight detection can be secured.

By adopting the configuration illustrated in FIG. 8C, robustness of line-of-sight detection can be secured without causing members such as each lighting 24 and each light-shielding member 35 to protrude in the direction of the eyeball of the user. Therefore, it is possible to provide the camera body 1 capable of reducing the influence of the aberration of the corneal reflection image without increasing the size of the apparatus.

As described above, the optimum distance from the position of the light-emitting unit 37 to the intersection 40 in each lighting 24 depends on the distance between the optical axis 11 and the position of the light-emitting unit 37. Referring to FIG. 3, in each of an IRED 25, an IRED 29, an IRED 30, and an IRED 34 having a particularly short distance from the optical axis 11, it is desirable to set the distance from the position of the light-emitting unit 37 to the intersection 40 to be short. In contrast, in each of an IRED 26, an IRED 27, an IRED 32, and an IRED 33 having a particularly long distance from the optical axis 11, it is desirable to set the distance from the position of the light-emitting unit 37 to the intersection 40 to be long.

### Third Embodiment

In Second Embodiment, the positional relationship between the light-emitting unit 37 and the light-shielding member 35 is adjusted according to the distance between the optical axis 11 and the light-emitting unit 37. In Third Embodiment, an example will be described in which the positional relationship between a light-emitting unit 37 and a light-shielding member 35 is adjusted according to the distance between a line-of-sight sensor unit 8 and the light-emitting unit 37.

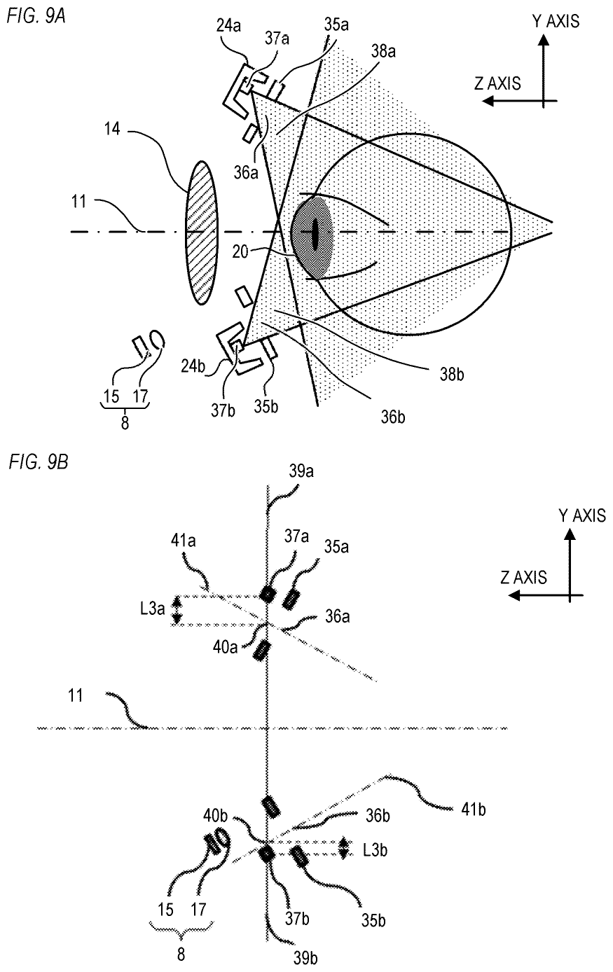

FIG. 9A illustrates an example in which two lightings 24 and two light-shielding members 35 are arranged in Third Embodiment, and illustrates an example in which the corneal distance (distance between a G3 lens 14 and a cornea 20 in the direction of an optical axis 11) is short. Of the two lightings 24, the one with a longer distance between the position of a light-emitting unit 37 and the line-of-sight sensor unit 8 is referred to as a “first lighting 24a”, and the one with a shorter distance between the position of a light-emitting unit 37 and the line-of-sight sensor unit 8 is referred to as a “second lighting 24b”.

At this time, as illustrated in FIG. 9B, in the configuration in which a “distance from the line-of-sight sensor unit 8 to the position of a first light-emitting unit 37a” is longer than a “distance from the line-of-sight sensor unit 8 to the position of a second light-emitting unit 37b”, a distance L3a is longer than a distance L3b.

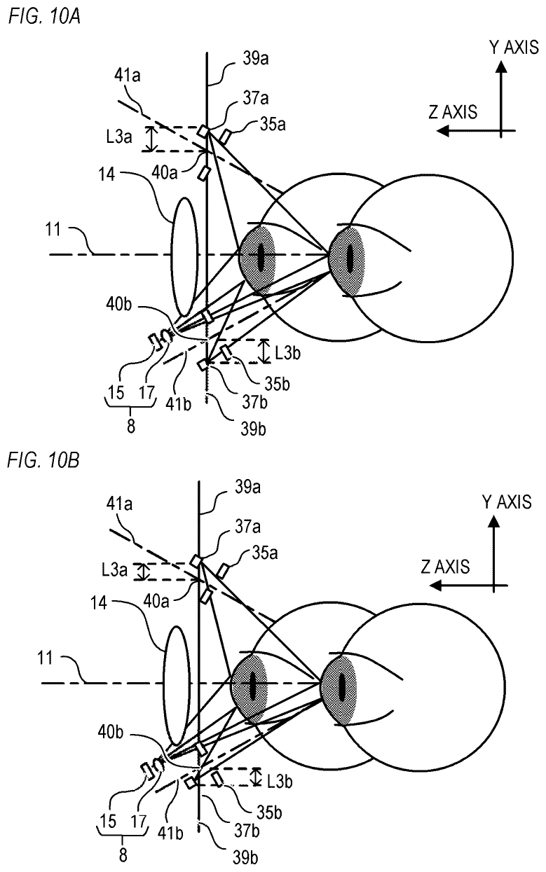

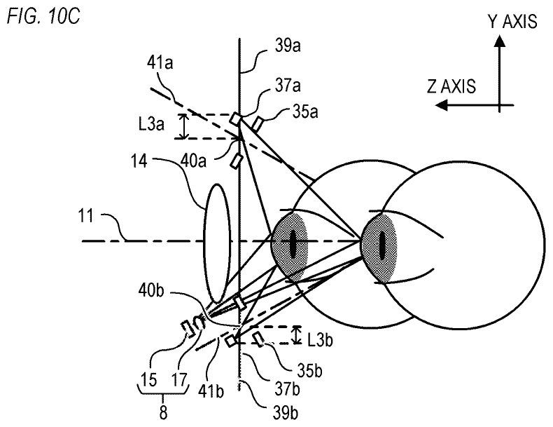

An effect of such a configuration will be described with reference to FIGS. 10A to 10C. Each of FIGS. 10A to 10C is a schematic diagram in which an eyeball in a case where the corneal distance is long and an eyeball in a case where the corneal distance is short are overlapped. In addition, an optical path of light (infrared light) emitted from the first lighting 24a or the second lighting 24b, specularly reflected on the surface of a cornea 20, and directed to a line-of-sight sensor chip 15 is overlapped.

FIG. 10A illustrates a configuration example in a case where the distance L3a and the distance L3b are relatively long and equal to each other. In this example, in a case where the corneal distance is long, light emitted from the second light-emitting unit 37b is blocked by a second light-shielding member 35b, so that the specular reflection image of the second light-emitting unit 37b cannot be acquired.

FIG. 10B illustrates a configuration example in a case where the distance L3a and the distance L3b are relatively short and equal to each other. In this example, in a case where the corneal distance is short, the light emitted from the first light-emitting unit 37a is blocked by a first light-shielding member 35a, so that the specular reflection image of the first light-emitting unit 37a cannot be acquired.

In contrast, FIG. 10C illustrates a configuration example in a case where the distance L3a is longer than the distance L3b. FIG. 10C is a diagram illustrating the configuration according to Third Embodiment. In such a configuration, in both a case where the corneal distance is short and a case where the corneal distance is long, specular reflection images of both the first light-emitting unit 37a and the second light-emitting unit 37b can be acquired, and robustness of line-of-sight detection can be secured.

With the configuration illustrated in FIG. 10C, robustness of line-of-sight detection can be secured without causing members such as each lighting 24 and each light-shielding member 35 to protrude in the direction of the eyeball of the user. Therefore, it is possible to provide a line-of-sight detection apparatus (camera body 1) capable of reducing the influence of the aberration of the corneal reflection image without increasing the size of the line-of-sight detection apparatus.

As described above, the optimum distance from the position of the light-emitting unit 37 to the intersection 40 in each lighting 24 depends on the distance between the line-of-sight sensor unit 8 and the position of the light-emitting unit 37. Referring to FIG. 3, in each of an IRED 29 and an IRED 30 in which the distance to the line-of-sight sensor unit 8 is particularly short, it is desirable that the distance from the position of the light-emitting unit 37 to an intersection 40 be short. In contrast, in each of an IRED 26 and an IRED 33 in which the distance to the line-of-sight sensor unit 8 is particularly long, it is desirable that the distance from the position of the light-emitting unit 37 to the intersection 40 be long.

In addition, in the above description, “if A is B or more, the process proceeds to step S1, and if A is smaller (lower) than B, the process proceeds to step S2” may be read as “if A is larger (higher) than B, the process proceeds to step S1, and if A is B or less, the process proceeds to step S2”. Conversely, “if A is larger (higher) than B, the process proceeds to step S1, and if A is B or less, the process proceeds to step S2” may be read as “if A is B or more, the process proceeds to step S1, and if A is smaller (lower) than B, the process proceeds to step S2”. Accordingly, unless a contradiction arises, “A or more” may be read as “larger (higher; longer; more) than A”, and “A or less” may be read as “smaller (lower; shorter; less) than A”. Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

Furthermore, in the above-described embodiments, the case where the present invention is applied to the imaging apparatus is described as an example, but the present invention is not limited to this example and can be applied to any line-of-sight detection apparatus capable of detecting a line-of-sight. The line-of-sight detection apparatus capable of detecting a line-of-sight may be a computer, a smartphone, a tablet terminal, a digital camera, or a home appliance.

According to the present invention, it is possible to provide a line-of-sight detection apparatus capable of preventing an increase in size and detecting a line-of-sight with high accuracy.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069482, filed on Apr. 23, 2024, which is hereby incorporated by reference herein in its entirety.

What is claimed is:

1. A line-of-sight detection apparatus comprising:
a display apparatus;
an optical system configured to deliver first light of an image displayed by the display apparatus to an eye of a user along an optical axis;
a first lighting apparatus including a first light-emitting member configured to irradiate the eye of the user with second light;
a first light-shielding member having a first opening configured to limit an irradiation range of the second light with which the first light-emitting member irradiates the eye of the user; and
an imaging apparatus configured to captures the eye of the user on a basis of the second light reflected by the eye of the user; wherein
a distance from a position of the first light-emitting member to the optical axis is longer than a distance from a first intersection of a plane orthogonal to the optical axis and passing through the position of the first light-emitting member and a central axis of the first opening to the optical axis.

2. The line-of-sight detection apparatus according to claim 1, wherein
the first light is visible light, and
the second light is infrared light.

3. The line-of-sight detection apparatus according to claim 1, wherein
a positional relationship between the first light-emitting member and the first light-shielding member is set on a basis of the distance from the position of the first light-emitting member to the optical axis.

4. The line-of-sight detection apparatus according to claim 1, wherein
a positional relationship between the first light-emitting member and the first light-shielding member is set on a basis of a distance from the position of the first light-emitting member to the imaging apparatus.

5. The line-of-sight detection apparatus according to claim 1 further comprising:
a second lighting apparatus including a second light-emitting member configured to irradiate the eye of the user with the second light; and
a second light-shielding member having a second opening configured to limit an irradiation range of the second light with which the second light-emitting member irradiates the eye of the user; wherein
a distance from a position of the second light-emitting member to the optical axis is longer than a distance from a second intersection of a plane orthogonal to the optical axis and passing through the position of the second light-emitting member and a central axis of the second opening to the optical axis.

6. The line-of-sight detection apparatus according to claim 5, wherein
in a case where the distance from the position of the first light-emitting member to the optical axis is longer than the distance from the position of the second light-emitting member to the optical axis, a distance from the position of the first light-emitting member to the first intersection is longer than a distance from the position of the second light-emitting member to the second intersection.

7. The line-of-sight detection apparatus according to claim 5, wherein
in a case where a distance from the position of the first light-emitting member to the imaging apparatus is longer than a distance from the position of the second light-emitting member to the imaging apparatus, a distance from the position of the first light-emitting member to the first intersection is longer than a distance between the position of the second light-emitting member to the second intersection.
